(19) United States
(12) Patent Application Publication
(10) Pub. No.: US 2024/0014738 A1
(43) Pub. Date: Jan. 11, 2024

(54) DC CONVERTER ARRANGEMENT, ON-BOARD ELECTRICAL SYSTEM FOR AN ELECTRIC VEHICLE AND METHOD FOR OPERATING A DC CONVERTER ARRANGEMENT

(71) Applicant: Robert Bosch GmbH, Stuttgart (DE)

(72) Inventor: Gholamabas Esteghlal, Stuttgart-Weilimdorf (DE)

(21) Appl. No.: 18/253,991

(22) PCT Filed: Oct. 6, 2021
(86) PCT No.: PCT/EP2021/077566

§ 371 Date: May 23, 2023

(30) Foreign Application Priority Data
Nov. 30, 2020 (DE) 10 2020 215 061.3

(51) Int. Cl. H02M 3/158

(52) U.S. Cl. CPC H02M 3/1584; B60L 2210/10; B60L 50/60

(57) ABSTRACT

The present invention relates to a DC converter arrangement comprising multiple DC converters arranged in parallel. The individual DC converters of the DC converter arrangement are set to different target output voltages. This ensures a stable operation of the DC converter arrangement with the multiple DC converters.

### BACKGROUND

The present invention relates to a DC converter arrangement as well as to a method for operating a DC converter arrangement. The present invention further relates to an on-board electrical system for an electric vehicle.

Fully or at least semi-electrically driven vehicles generally comprise an electrical energy storage means, such as a traction battery. This traction battery provides the electrical energy required in order to propel the electric vehicle. The traction battery typically supplies an output voltage of multiple hundreds of volts and supplies what is referred to as a high-voltage network of the vehicle. Moreover, such a vehicle generally comprises multiple electrical consumers supplied at a lower electrical voltage via a low-voltage network. For coupling the high-voltage network and the low-voltage network, and in particular for transferring electrical energy from the high-voltage network to the low-voltage network, what are referred to as DC converters can be provided, which convert an electrical DC voltage from the high-voltage network into a DC voltage for the low-voltage network.

Publication DE 10 2009 028 147 A1 describes a circuit arrangement for an on-board electrical system of an electric vehicle, in which case a DC converter (DC/DC converter) is provided for coupling between two on-board electrical system parts.

### SUMMARY

The present invention creates a DC converter arrangement, a method for operating a DC converter arrangement, and an on-board electrical system for an electric vehicle.

Accordingly, the following is provided:

A DC converter arrangement comprising multiple DC converters. The multiple DC converters are each designed to convert a common DC input voltage into a DC output voltage. Furthermore, the DC converters are each designed to provide the converted DC output voltage at a common node. For this purpose, the individual DC converters can be electrically coupled to one another on the output side at the node. A different target output voltage is set in at least two of the multiple DC converters.

The following is furthermore provided:

An on-board electrical system for an electric vehicle having a high-voltage network, a low-voltage network, and a DC converter arrangement according to the present invention. The high-voltage network is designed to be coupled to a high-voltage electrical energy storage means. In particular, the high-voltage network can provide an electrical DC voltage to the DC converter arrangement. For this purpose, the DC converter arrangement is electrically coupled to the high-voltage network at an input. Furthermore, the individual DC converters of the DC converter arrangement are electrically coupled to the low-voltage network at the common node.

Finally, the following is provided:

A method for operating a DC converter arrangement comprising multiple DC converters. Each of the DC converters is designed to convert a common DC input voltage into a DC output voltage and to provide the converted DC output voltage at a common node. The method comprises a step for setting different target output voltages in at least two of the multiple DC converters.

The present invention is based on the finding that the maximum output current or maximum output power of a DC converter is generally limited. Multiple DC converters can be connected in parallel in order to increase the output power. In this case, additional measures must generally be taken in order to synchronize the individual DC converters with one another and to optionally avoid instabilities when regulating the DC converters.

It is therefore one idea of the present invention to take this finding into account and to create a DC converter arrangement having multiple parallel-connected DC converters that is reliable and as simple as possible. For this purpose, it is provided that, in a DC converter arrangement having multiple DC converters, the individual DC converters are set to slightly different target output voltages. In this way, the individual DC converters of the DC converter arrangement can be prioritized differently. This enables an alignment in the performance of the individual DC converters without the individual DC converters needing to be synchronized with one another by means of additional connections or control means. The individual DC converters can be operated and controlled individually in this way. A data exchange or another manner of synchronizing the individual controls of the DC converters is not required in this case.

In this context, the target output voltage of the individual DC converters specifies the target output voltage to be set by the respective control circuit of a DC converter. If the output current or the output power of a DC converter reaches a maximum allowable value or specified value, the respective DC converter can no longer maintain the specified target output voltage. As a result, the respective DC converter will provide a lower output voltage due to the limitation of the output current or output power.

Given that the individual DC converters of the DC converter arrangement according to the invention are set to different target output voltages, the output voltage can, upon exceeding the maximum output power or the maximum output current of a DC converter, drop until the output voltage of this DC converter reaches or falls below the target output voltage of a further DC converter. As a result, the control loop of this further DC converter will activate the further DC converter and will also provide an output current or output power.

However, because the present invention is not limited to only two DC converters, DC converter arrangements having more than two DC converters are also possible, in which case the individual DC converters can be set to different target output voltages so that, at an increasing load on the output side of the DC converter arrangement and an associated voltage drop, more and more DC converters of the DC converter arrangement actively provide an output power or an output current until a stable operating point can be achieved.

The individual DC converters of the DC converter arrangement can in this context generally be any suitable DC converters suitable for converting an input DC voltage into an output DC voltage according to a specified target output voltage. As already stated, the individual DC converters can each comprise individual control and actuation means independent from the other DC converters.

For example, the DC converter arrangement can be fed by a high-voltage network of an electric vehicle and can supply a low-voltage network of said vehicle on the output side. In this way, for example, electrical consumers in the low-voltage network can be supplied with electrical energy of a traction battery via the DC converter arrangement. Given increasing power demand on the low-voltage side, one or more of the DC converters will in this case gradually reach their maximum power output, and the electrical voltage on the low-voltage side will then drop. As the electrical voltage on the low-voltage side decreases, the target output voltage of further DC converters of the DC converter arrangement is subsequently reached or not reached, so these DC converters actively perform a voltage conversion from the high-voltage side to the low-voltage side.

According to one embodiment, each of the multiple DC converters of the DC converter arrangement is set to a different target output voltage. In this way, it is possible that further DC converters are gradually activated at an increasing load on the output side and thus provide a contribution to the power conversion from the input side to the output side. By setting different target output voltages, i.e. target values, for the various DC converters of the DC converter arrangement, it is thus possible to set the operating points of the individual DC converters without needing to synchronize the individual DC converters with one another via data or synchronization lines.

According to one embodiment, the individual DC converters of the DC converter arrangement are designed to set a different target output voltage upon each restart or initialization. In this way, each time the DC converter is restarted or initialized, the DC converter in the DC converter arrangement is respectively configured at a different target output voltage for the individual DC converters. This enables a new, different prioritization of the individual DC converters to occur each time the device is restarted or initialized. Thus, for example, it is possible that the individual DC converters are alternately prioritized higher so that a more even loading of all DC converters in the DC converter arrangement takes place.

According to one embodiment, the DC converters of the DC converter arrangement are designed to select a target output voltage cyclically from a group of specified target output voltages upon each restart or initialization and to set the selected target output voltage. In this way, for example, a group of specified target output voltages can be defined. Upon each restart or initialization, a DC converter then selects one of the specified target output voltages from this group of specified target output voltages according to a specified scheme, or cyclically. The specified group of the target output voltages can in this case be specified individually in each of the DC converters. For example, in all DC converters, the same target output voltages can be specified as a group, but the individual DC converters are in this case configured so that the individual DC converters each select different target output voltages from that group. In this way, for example, in the entirety of the DC converters according to the specified scheme, for example in a rotation, a target output voltage can be determined and set for each DC converter individually from the group of the target output voltages.

According to one embodiment, the DC converters are designed to respectively limit the output current to a maximum value. In principle, any other suitable measures are also possible in order to limit the maximum output power of the DC converters.

If the output current or the output power of a DC converter reaches the specified maximum value, the target output voltage will not be able to be maintained further on the control loop of the DC converter on the output side in case of further loading, so the output voltage value drops on the output side.

According to one embodiment, the individual DC converters of the DC converter arrangement can each feature an individual maximum output current or maximum output power. In particular, the output currents or output powers of the individual DC converters of the DC converter arrangement can be different. However, in principle, a DC converter arrangement having multiple identical or similar DC converters is also possible, each featuring an identical or at least approximately identical maximum output current or maximum output power.

According to one embodiment, the DC converters of the DC converter arrangement are designed to raise the respective target output voltage if the DC converter supplies its maximum output current or maximum power. For example, the target output voltage of a DC converter can be continuously increased or gradually increased in stages until a maximum desired output voltage of the DC converter arrangement is reached. In this way, after reaching the maximum output current or the maximum output power of a DC converter for multiple DC converters of a DC converter arrangement, an operating state can be achieved in which all active DC converters contribute as equal a proportion as possible to the total output power or the total output current.

According to one embodiment, the DC converters of the DC converter arrangement are designed to lower the respective target output voltage after the respective DC converter has previously raised the respective target output voltage. In particular, the DC converter can initiate a lowering of the target output voltage after the respective target output voltage has been raised for a specified period of time. In this way, it is possible to return to the originally set target output voltage if the target output voltage has been temporarily raised. The lowering of the target output voltage can in particular be carried out incrementally, for example in specified stages.

The embodiments and further developments hereinabove can be combined with one another as desired, to the extent that they are advantageous. Further embodiments, developments, and implementations of the invention also include combinations of features of the invention not explicitly specified hereinabove or hereinafter with respect to the exemplary embodiments described. The skilled person will in particular also add individual aspects as improvements or additions to the respective basic forms of the invention.

### BRIEF DESCRIPTION OF THE DRAWINGS

Further features and advantages of the invention are explained hereinafter with reference to the drawings.

Shown are:

FIG. 1: a schematic view of a block diagram of a DC converter arrangement according to one embodiment; and

FIG. 2: a schematic view of a flowchart as it forms the basis of a method for operating a DC converter arrangement according to one embodiment.

### DETAILED DESCRIPTION

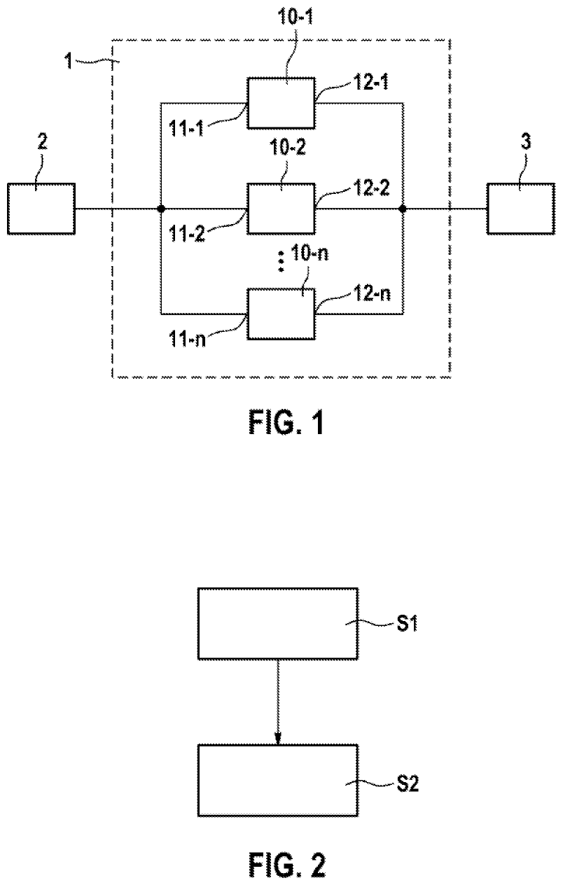

FIG. 1 shows a schematic view of a block diagram of a DC converter arrangement 1 according to one embodiment. For example, the DC converter arrangement 1 can be coupled to a DC voltage source 2 on the input side. On the output side, the DC converter arrangement 1 can be connected to one or more electrical consumers 3. In addition to the electrical consumers 3, an electrical energy storage means can also be provided additionally or alternatively and be charged by the power supplied by the DC converter arrangement 1 and able to output this electrical power at a later time. For example, in an electric vehicle, the DC converter arrangement 1 can be connected to a high-voltage network on the input side and can feed a low voltage on the output side. In this case, for example, the DC voltage source 2 on the input side of the DC converter arrangement 1 can comprise a traction battery of an electric vehicle. For example, the electrical consumers 3 on the low-voltage side can be additional units, e.g., an A/C compressor, a steering aid, lighting components, or the like.

As can be seen in FIG. 1, the DC converter arrangement 1 can comprise multiple DC converters 10-i. In this context, the number of three DC converters 10-i shown in this case is to be understood as merely exemplary and does not represent a limitation of the present invention. In principle, only two, or more than three, DC converters 10-i arranged in parallel are possible. The DC converters 10-i are electrically connected to one another at their input side 11-i. For example, all DC converters 10-i at their inputs 11-i can be connected to the high-voltage network of an electric vehicle or any other DC voltage source 2. The outputs 12-i of the DC converter 10-i are also electrically connected to one another and can, for example, together feed a low-voltage network of an electric vehicle or any other electrical consumer 3. In principle, any other desired components can be provided on the input side as well as on the output side, e.g. sonic elements, for the individual switching on or off of individual DC converters 10-i.

Each of the DC converters 10-i can convert the electrical DC voltage supplied by the DC voltage source 2 into a DC voltage and can provide it at the corresponding output 12-i. In conventional DC converter arrangements with multiple DC converters connected in parallel, additional synchronization of the individual DC converters is usually required in this case.

However, such an additional synchronization of the DC converters 10-i is not required in the embodiment shown in FIG. 1. Rather, the respective target output voltages, i.e., the target values for the output voltage of the individual DC converters 10-i, are slightly different in the individual DC converters 10-i. If the low-voltage network connected on the output side of the DC converter arrangement 1 is to be operated in, e.g., a voltage range between approximately 12 and 14 V, then the target output voltages can differ by 0.1 to 0.5 V in the individual DC converters 10-i. However, depending on the number of DC converters 10-i used and the voltage level of the voltage network connected to the output side of the DC converter arrangement 1, other voltage differences between the target output voltages of the individual DC converters 10-i are generally also possible.

If the voltage side on the output side of the DC converter arrangement 1 is not loaded or only very slightly loaded, the voltage on the output side of the DC converter arrangement 1 will increase to a voltage value corresponding to the target output voltage of the DC converter 10-i with the highest target output voltage. In this case, only the DC converter(s) 10-i set to the highest target output voltage will generally supply an output current.

Given increasing load on the voltage network on the output side of the DC converter arrangement 1, the maximum output current of the DC converter 10-i with the highest target output voltage will be achieved. If the load then increases even further, the corresponding DC converter 10-i will not be able to maintain the target output voltage, and the electrical voltage will therefore drop.

If, due to the increasing load, the electrical voltage on the output side of the DC converter arrangement drops to a value corresponding to the target output voltage of a DC converter 10-i with a lower target output voltage, or if the electrical voltage at the output of the DC converter arrangement 1 is possibly below the target voltage, the DC converter 10-i whose target output voltage is reached or not reached will also be activated. As a result, all DC converters 10-i always provide a contribution whose target output voltage is greater than or equal to the value of the electrical voltage on the output side of the DC converter arrangement 1.

If the target output voltages of the individual DC converters 10-i of the DC converter arrangement 1 are set differently, then, given an increasing load on the output side of the DC converter arrangement 1 (and thus a decreasing electrical voltage) more and more DC converters will gradually make a contribution to the power on the output side of the DC converter arrangement 1.

If, during operation of the DC converter arrangement 1, a DC converter 10-i detects that its maximum output power or maximum output current has been reached, this DC converter can continuously or incrementally increase its target output voltage. In particular, such a DC converter 10-i can increase its target output voltage to a specified target value, e.g., the maximum target output voltage of the DC converter 10-i in the DC converter arrangement 1. A more even load distribution can be achieved in this way. In the further course, such a DC converter 10-i, which has increased its target output voltage, can also continuously or incrementally lower its target output voltage after a specified period of time. In particular, said lowering can occur until the originally set target output voltage is lowered. In this way, the initial configuration of the target output voltages can be set again when the power demand on the output side of the DC converter arrangement 1 drops again.

The individual DC converters 10-i can generally be any DC converter suitable for converting a DC voltage supplied on the input side into the required DC voltage on the output side. In particular, these can be multiple identical or similar DC converters 10-i. However, combinations having different DC converters 10-i are also possible. For example, different DC converters can be used for different maximum output currents or output powers.

In one embodiment, it is possible that each of the DC converters 10-i is fixedly set to a specified target output voltage. In addition, however, it is also possible that the target output voltages are varied. For example, the individual specification for the target output voltages in the individual DC converters 10-i can be varied at each restart or initialization of the DC converter arrangement 1. For example, each time the DC converter arrangement 1 is restarted or initialized, a different DC converter 10-i can be set to the highest target output voltage. In this way, a more even load on the individual DC converters 10-i is possible. For example, a counter can be provided in each DC converter 10-i, which is advanced every time the DC converter arrangement 1 is restarted or initialized. Depending on the value of this counter, a respective target output voltage can be selected from a group of specified target output voltages. In this case, it can be ensured that different target output voltages are selected in the individual DC converters 10-i upon each initialization or restart. For example, each of the DC converters 10-i can select a different value for the target output voltage cyclically from a group of specified target output voltages upon each restart or initialization. Furthermore, any other desired methods for selecting the target output voltages in the individual DC converters 10-i are of course possible.

FIG. 2 shows a schematic diagram of a flowchart of a method for operating a DC converter arrangement with multiple DC converters 10-i. In principle, the method can perform any of the steps previously described in connection with the DC converter arrangement 1. Accordingly, the DC converter arrangement 1 described above can also comprise any desired components suitable for implementing the method described hereinafter.

In step S1, different target output voltages are set in the DC converter arrangement 1 with multiple DC converters 10-i connected in parallel in the individual DC converters.

The DC converter arrangement 1 can then be operated in step S2 such that the individual DC converters 10-i each set their target output voltage at the output until a maximum output current or maximum output power is reached.

If the electrical voltage at the output of a DC converter 10-i exceeds the target output voltage, then the respective DC converter 10-i is deactivated.

In summary, the present invention relates to a DC converter arrangement comprising multiple DC converters arranged in parallel. The individual DC converters of the DC converter arrangement are in this case set to different target output voltages. A stable operation of the DC converter arrangement with the multiple DC converters is thus possible without the need for the individual DC converters to be synchronized with one another by means of additional data or synchronization connection.

1. A DC converter arrangement (1) comprising:
multiple DC converters (10-i), each being configured to convert a common DC input voltage into a DC output voltage and to provide the converted DC output voltages at a common node,
wherein, in at least two of the multiple DC converters (10-i), a different target output voltage is set.

2. The DC converter arrangement (1) according to claim 1, wherein each of the multiple DC converters (10-i) is set to a different target output voltage.

3. The DC converter arrangement (1) according to claim 1, wherein the multiple DC converters (10-i) are respectively configured to set a different target output voltage upon each restart or initialization.

4. The DC converter arrangement (1) according to claim 3, wherein the multiple DC converters (10-i) are configured to select and set a respective target output voltage cyclically from a group of specified target output voltages upon each restart or initialization.

5. The DC converter arrangement (1) according to claim 1, wherein the multiple DC converters (10-i) are each configured to limit a maximum output current to a specified maximum value.

6. The DC converter arrangement (1) according to claim 5, wherein each DC converter (10-i) features an individual maximum output current.

7. The DC converter arrangement (1) according to claim 5, wherein the DC converters (10-i) are configured to raise the respectively set target output voltage if the DC converter (10-i) outputs the respective maximum output current.

8. The DC converter arrangement (1) according to claim 7, wherein the DC converters (10-i) are configured to lower the respective target output voltage after the DC converter (10-i) has previously raised the target output voltage.

9. An on-board electrical system for an electric vehicle, comprising:
a high-voltage network configured to be coupled to a high-voltage electrical energy storage means (2);
a low-voltage network; and
a DC converter arrangement (1) according to one of claim 1,
wherein the DC converter arrangement (1) is electrically coupled to the high-voltage network at one input, and the common node of the multiple DC converters (10-i) is electrically coupled to the low-voltage network.

10. A method for operating a DC converter arrangement (1) of multiple DC converters (10-i), each being configured to convert a common DC input voltage into a DC output voltage and to provide the converted DC output voltages at a common node,
wherein the method comprises a step (S1) for setting different target output voltages in at least two of the multiple DC converters (10-i).
